(19) United States
(12) Patent Application Publication
(10) Pub. No.: US 2014/0161257 A1
(43) Pub. Date: Jun. 12, 2014

(54) LOCATION-SPECIFIC SECURITY AND ACCESS SYSTEM BASED ON RADIO FREQUENCY SIGNAL ATTENUATION

(71) Applicant: Roger R. Dube, Pittsford, NY (US)

(72) Inventor: Roger R. Dube, Pittsford, NY (US)

(73) Assignee: DIGITAL AUTHENTICATION TECHNOLOGIES, INC., Boca Raton, FL (US)

(21) Appl. No.: 13/897,384

(22) Filed: May 18, 2013

Related U.S. Application Data
(63) Continuation-in-part of application No. 12/469,393, filed on May 20, 2009, now Pat. No. 8,453,005.
Application No. 12/469,393 is a continuation of application No. 10/987,553, filed on Nov. 13, 2004, now Pat. No. 7,551,739.
(60) Provisional application No. 60/520,094, filed on Nov. 13, 2003.

(51) Int. Cl. H04W 12/06; H04L 29/06

(52) U.S. Cl. CPC H04W 12/06; H04L 63/0428
USPC 380/258

(57) ABSTRACT

An invention is provided for a providing authentication in a network environment. current radio frequency (RF) measurement data is received from a client device, wherein the current RF measurement data is based on a measured effect of the intervening materials on RF signals received at the client device from a remote RF source. The received RF measurement data is compared with stored RF measurement data, which is acquired at a previous time and is based on a measured effect of the intervening materials on RF signals received at a specific space from a remote RF source. Authentication is provided based on the result of comparing the received RF measurement data with stored RF measurement data.

### CROSS REFERENCE TO RELATED APPLICATIONS

This application is a continuation-in-part of U.S. patent application Ser. No. 12/469,393, filed May 20, 2009, entitled “System and Method for Container Monitoring, Real Time Authentication, Anomaly Detection, and Alerts,” which is a continuation of U.S. patent application Ser. No. 10/987,553, filed Nov. 13, 2004 now U.S. Pat. No. 7,551,739, entitled “Method For Container Monitoring, Real Time Authentication, Anomaly Detection And Alerts,” which claims the benefit of U.S. Provisional Patent Application having Ser. No. 60/520,094, filed on Nov. 13, 2003, and entitled “Method for Container Monitoring, Real Time Authentication, Anomaly Detection and Alerts,” wherein all of the U.S. priority applications are hereby incorporated by reference.

### BACKGROUND OF THE INVENTION

1. Field of the Invention

This invention relates generally to network security and more specifically to a system and method for authenticating the source location of a remote electronic device user (or client) seeking electronic access to, or seeking to perform an electronic transaction with, a host device.

2. Description of the Related Art

The use of public and private networks has fundamentally altered the manner in which business enterprises and government agencies communicate and conduct business. For example, the Internet, intranets and extranets are used to store, analyze and transmit information between and within organizations, and permit interactive, local, national or global communication on a real-time basis. Moreover, these networks are now used for electronic business-to-customer retail commerce and for electronic business-to-business commerce of all types.

In order to achieve its full potential, however, e commerce must overcome numerous security and related issues, including concerns relating to hacker attacks, merchant impersonation, data confidentiality and integrity, fraud, and transaction repudiation. Key to all of these problems is the need to authenticate a user's identity in a manner that is extremely difficult or impossible to defeat.

For example, to improve the confidentiality of communications and commerce over networks, public key infrastructure (“PKI”) encryption systems have been developed. Using PKI encryption, digital messages are encrypted and decrypted using ciphers or keys. A conventional public and private key pair includes a public key and a private key. Each user of the system has a public key and a private key and must know the public key of the intended recipients of its messages. In general, a message is encrypted and sent by a sender using the recipient's public key and is then received and decoded by the recipient using his private key.

For example two network computer users, Alice and Bob, each have their own public and private key pair. The private keys are secret numbers to which only the owner has access. In general each public is generated using the following formula:

GxmodP, (1)

where G and P are large prime numbers and x is the user's private key. In this manner, eavesdroppers would have great difficulty determining x even if the values of G and P are known. Hence, the public keys can be broadly disseminated without revealing the related private key. For example, Bob and Alice provide their public keys to each other prior to initiation of encrypted communication.

Thereafter, whenever encrypted communication is to occur, the sender utilizes their private key in conjunction with the recipient's public key to encrypt the data being sent. Upon receipt, the recipient decrypts the data using the recipient's private key. For example, when Alice wishes to send Bob an encrypted message, Alice encrypts the message using her private key in conjunction with Bob's public key. Upon receipt, Bob decrypts the message using his private key.

PKI systems attempt to provide a high level of security and confidentiality because messages can be decoded only by persons having the recipient's private key. However, it is well known in the industry that a weakness of PKI technology is its susceptibility to the “man-in-the-middle” attack.

For example, assume a new person, Cindy, enters the example as a middleman. As before, Alice has a public and private key pair and Bob has a public and private key pair. In addition, Cindy, the middleman, has a public and private key pair. If Cindy can intercept a transmission between Bob and Alice, she can trick them into using her public key. In this attack, the attacker intercepts the transmission of a public key and replaces it with the attacker's false key, thereby effectively replacing the true sender as the trusted party. This enables the attacker to send, receive and decode messages intended for the original legitimate user.

For example, during a “man-in-the-middle” attack, Cindy intercepts Alice's public key and replaces it with Cindy's public key. Similarly, Cindy intercepts Bob's public key and replaces it with Cindy's public key. Bob and Alice each believe they have each other's public key, however, they actually have Cindy's public key. Later, during encrypted transmissions, both Alice and Bob unknowingly use Cindy's public key in conjunction with their respective private keys to encrypt messages to each other, which are actually intercepted by Cindy. Cindy can decrypt the messages using her private key, and further, re-encrypt the messages using Cindy's private key and the proper recipient's public key.

Alternatively, an attacker can also submit false public key entries to certificate managers and effectively masquerade as another person. The implementation and use of PKI technology over remote sites without independent verification of identity poses many risks and must be used judiciously.

As described above, PKI encryption systems do not provide assurance as to the authenticity of the sender. An attempt has been made to address this problem through use of digital certification systems that use public and private keys to create special files, or digital certificates or signatures. The digital certificates are encoded using a sender's private key and, upon receipt, decoded by the recipient using a copy of the sender's public key obtained from a remote trusted administrator. For example, a certification authority (CA), which confirms the identity of the sender through transmissions over the Internet or other network, can be used to disseminate public keys.

Certifying authorities generally are either public or private. Public certifying authorities are independent third parties that issue digital certificates for use in Internet applications, after conducting due diligence as to the identity of the subscriber. Private certifying authorities are entities that issue their own digital certificates, often to closed communities of users, such as customers or employees, for use in Internet, intranet, extranet or other applications.

However, the Certifying Authority approach has numerous flaws and loopholes. For example, it is well known in the PKI industry that a person can create a key pair and claim to be someone else. By inserting an unauthorized public key in a transaction or on a public database, the masquerading party creates ambiguity and can receive encrypted files intended for the person he is impersonating. This flaw, combined with a lack of location and apparatus ID information, makes detection of the identity deception extremely difficult.

Remote certifying authority technologies are fundamentally self-limiting. As explained above, remote certifying authorities use multiple transmissions over the Internet to receive, certify, and then deliver digital certificates. There are at least three Internet transmissions of information for each digital certificate created, including the original request for a certificate, the delivery of a certificate to the initiator, and the transmission of the original document and certificate to the final intended recipient. Moreover, should the recipient want to certify his receipt, three additional transmissions must occur. As more users rely upon remote certifying authorities for digital certificates, the demand for Internet bandwidth will increase geometrically, ultimately slowing the system down. The more the system is used, the slower it will become, causing users to turn away from CA technology. Due to this self-limiting property, it is unlikely that remote certifying authority technologies will ever become the universal standard for identity authentication.

Moreover, revocation of privileges and identity authentication are not immediate using CA technology. Since libraries of public keys are storied in multiple databases that reside on the servers of multiple Certifying Authorities, a significant delay exists between the time that a service elects to revoke key privileges and the time that the revocation information has fully propagated to all possible public key databases and servers. More and more large organizations are recognizing that the maintenance of current information about authorized and unauthorized personnel across multiple remote CA's is a daunting task, which is further complicated by the fact that a person whose credentials have been revoked may continue to have access privileges until the revocation propagation is complete. This raises security concerns about sensitive data being exposed to dismissed or disgruntled employees whose credentials have been revoked. In the today's CA system, those employees have measurable time in which they may continue to access sensitive information against the will of their employer.

Commercial applications have a need for a verifiable means to demonstrate the occurrence of a particular e-commerce transaction or Internet communication, in order to reduce the risk of fraud or repudiation of a transaction or communication by the parties. This need is present in the case of existing e-commerce applications, and will increase as e-commerce expands with the offering of additional software packages over the Internet through application service providers (ASPs) and the offering of additional material that is copyright protected (e.g., CD quality sound, video and images.)

A key to continuing e-commerce growth is an incontestable witness to a connection, download, file-creation or transmission that will create security of audit trails and transaction records. The common elements required to solve these problems include time and authenticated user location. Although it is necessary to record file activity on the receiving computer system, non-repudiation of a transaction requires recordation of the same file activity on the sender's computer system as well. Independent witnessing of time and location of events provides this non-repudiation.

Existing Remote Certifying Authorities attempt to identify both a specific document and the signer of the document, but these technologies cannot identify the exact time when a document or signature was created (as distinguished from when a document is received) because the time in a computer can be altered. Moreover, remote certification with a CA over the Internet or other network requires delay and transmission time, thereby preventing exact time confirmation. Existing attempts to deal with the problem of real-time verification are not effective because assurance is given only as to the time of document receipt, not creation.

A number of attempts have been made to increase system security in the prior art. The following is a list of prior art disclosures that provide some form of system security. However, as will be seen, none of the disclosures provides a level of security currently needed to ensure proper protection of today's highly sensitive transaction data.

Hissle et. al, in PCT publication WO 97009802, describe a method which the timestamp for a document is authenticated using a remote source of time such as GPS. Since the GPS satellite system has an independent and redundant source of time and date, the remote time can be compared to the local system time as a means of authenticating the system time and therefore the time of creation of a document. The external and local times are then compared and if the difference exceeds a preset range, the internal clock is updated. The disclosure further describes the creation of a digital timestamp or signature in which the authenticated time is combined with a summary of the file and the processor ID to provide authentication of the file's creation time. The concern here is that the system does not include the location of the file at its time of creation nor the identity of the user.

Murphy, in U.S. Pat. No. 5,640,452, discloses a method in which the location of a decryption chip is employed to restrict access to a broadcast signal. The location is determined locally by a GPS receiver and is compared against the authorized location set at the time of installation. For example, a digital satellite receiver dish could employ this technology to assure that clones of the decryption chip will not operate at any location other than that originally licensed, since their location will be incorrect. This technology does not authenticate the user in any way, nor does it authenticate the GPS location through any independent means. It further suffers from the fact that since the location detector sends an enabling signal to the decryption chip, the system will likely be defeated by insertion of the proper enabling signal, thereby bypassing the location requirement.

Loomis et. al., in U.S. Pat. No. 6,092,193, disclose a method for authenticating accumulated instrument data in which a summary of the data sampled at pre-set times are compiled in a sequential fashion and encrypted each time the total exceeds a pre-set value. By comparing the decrypted totals to the current total of the data in memory, alterations to the data can be detected and therefore declared invalid. The disclosure does not employ location, nor does it authenticate the user in any way in order to control access.

Schipper et. al., in U.S. Pat. No. 5,754,657, describe a process by which a message source is authenticated by its location. In this patent, the inventors employ a process by which the source of the message receives its location using GPS and appends a portion of that raw signal to the data. Part or all of the combined message can be encrypted. The signal is decrypted upon receipt, and the receiver uses the raw GPS signals to determine whether or not the source resides at its pre-authorized location. Unfortunately, a synthesized or pre-recorded GPS signal stream could be employed to facilitate masquerading by an unauthorized source.

In U.S. Pat. No. 5,757,916, MacDoran et. al. disclose a technique by which the raw satellite signals from a source computer are transmitted to a remote server that requires authentication. The MacDoran disclosure further employs a second source computer that also sends its raw GPS signals to the server. The server uses the raw signals from both sources to calculate their respective locations, which are compared against locations stored in the profiles for the two sources. In addition, a differential location vector is calculated from the raw signals, and this differential vector is also compared against the profiles to determine that it is consistent with the two authorized locations. In principle, since the satellites are continually moving and the calculations are performed on signals from two nearby locations, spoofing of the original source signal would be difficult. This system introduces the additional complication that an authenticated third party (the second source) must be on-line, receiving signals, and available for transmission in order to authenticate the first source. Availability of authentication and privacy of the two sources are concerns that surface here.

In view of the foregoing, there exists a need for enhanced authentication of the identity of a person initiating an electronic transaction, electronic file, document, or accessing an electronic file, document, or database. In order to avoid opportunities for interception, masquerading, “man-in-the-middle” attacks, and other forms of electronic fraud, there is also a need that such authentication not require any transmission of information to a remote third party, commonly referred to as “remote certifying authorities.” Furthermore, such authentication should preferably occur on a real-time basis, at the time of the transaction, file creation, or data access. Moreover, such authentication should preferably include location information that can be independently certified.

### SUMMARY OF THE INVENTION

Broadly speaking, embodiments of the present invention address these needs by providing a location-specific authentication system to authenticate remote users of protected network resources by verifying the remote is located at a specific space, without the need of specific geo-location information of the remote user or transmitting specific Global Positioning System (GPS) coordinates.

In one embodiment, a method for providing authentication in a network environment is disclosed. The method includes receiving current radio frequency (RF) measurement data from a client device, wherein the current RF measurement data is based on a measured effect of the intervening materials on RF signals received at the client device from a remote RF source. The received RF measurement data is compared with stored RF measurement data, which is acquired during a previous time and is based on a measured effect of the intervening materials on RF signals received at a specific space from a remote RF source. Authentication is provided based on the result of comparing the received current RF measurement data with stored RF measurement data.

In general, the stored RF measurement data can be acquired using dual frequency measurements of dielectric content of intervening material, or by measuring attenuation of single frequency due to scattering. The stored RF measurement data is mapped over time to create a location signature, which is a data space of values based on the measured effect of the intervening materials surrounding the specific space on RF signals mapped over specific period of time. In this manner, authentication can be provided when the current RF measurement data falls within a scope of the location signature for the specific space, and denied when outside the scope of the location signature. Similarly, the current RF measurement data from the client device can be a data space of values based on the measured effect of the intervening materials on RF signals collected over a shorter period of time than the specific period of time used to map the stored RF measurement data.

A further method for providing authentication in a network environment is disclosed in an additional embodiment of the present invention. The method includes sending a challenge request to a client device in communication with a receiver receiving RF signals from a remote source. The challenge request requests current RF measurement data for the receiver, which as mentioned above, is based on a measured effect of the intervening materials on RF signals received at the client device from a remote RF source. Once received, the current RF measurement data for the client device is provided to an authentication server. The authentication server has access to a location signature for a specific space, which is a data space of values based on the measured effect of the intervening materials surrounding the specific space on RF signals mapped over specific period of time. The current RF measurement data then is compared to the location signature for specific space to authenticate an access request. As above, the location signature can be acquired using dual frequency measurements of dielectric content of intervening material, or by measuring attenuation of single frequency due to scattering. Once acquired the location signature can be used for authentication. That is, authentication is provided when the current RF measurement data falls within a scope of the location signature for the specific space, and denied when the current RF measurement data does not fall within a scope of the location signature for the specific space.

In a further embodiment, a system for providing security for a protected network resource is disclosed. The system includes a protected network resource, and a database that stores a location signature for a specific space. As above, the location signature is a data space of values based on the measured effect of the intervening materials surrounding the specific space on RF signals mapped over specific period of time. An authentication computer also is included that is in communication with the protected network resource and the database. In operation, the authentication computer receives current RF measurement data for a client device, which is based on a measured effect of the intervening materials on RF signals received at the client device from a remote RF source. The authentication computer then compares the current RF measurement data to the location signature for the specific space to authenticate an access request and provide access to the protected network resource.

As above, the location signature can be acquired using dual frequency measurements of dielectric content of intervening material, or measuring attenuation of single frequency due to scattering. Similarly, a single-frequency GPS receiver is used to acquire the current RF measurement data at the client device, where the current RF measurement data is a data space of values based on the measured effect of the intervening materials on RF signals collected over a shorter period of time than the specific period of time used to map the location signature. The authentication computer authenticates the access request when the current RF measurement data falls within a scope of the location signature for the specific space, and denies or blocks the access request when the current RF measurement data does not fall within a scope of the location signature for the specific space.

The use of RF measurement data based on the measured effect of the intervening materials surrounding the specific space on RF signals is of particular advantage in the present invention because the RF measurement data has its origins in a physical process that lies along a line of sight between a distant remote source and a passive RF receiver. These physics-based values are incalculable and non-spoofable. Hence, only someone at the specific space will be to produce the same RF measurement data for authentication purposes.

Moreover, embodiments of the present invention advantageously do not utilize actual information about the geo-location of the specific space or the client device for authentication. As can be appreciated, false GPS signals can be sent to a GPS receiver that provide the receiver with false information about its current location using either spoofed signals or by employing a GPS signal generator. As a result, using actual GPS geo-location data is not a secure method to establish the location of a client device. Moreover, transmitting specific GPS coordinates for a geo-location creates a security concern that an eavesdropper monitoring a wide area network, such as the Internet, can obtain sensitive information about the user's geo-location. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing an RF receiver that utilizes the effect of intervening material on GPS RF data to facilitate authentication, in accordance with an embodiment of the present invention;

FIG. 2 is an illustration showing an exemplary single frequency receiver disposed within a building to illustration signal reflection, in accordance with an embodiment of the present invention;

FIG. 3 is a flowchart showing a method for characterizing a specific space for authentication purposes, in accordance with an embodiment of the present invention;

FIG. 4 is a conceptual diagram illustrating a location signature, in accordance with an embodiment of the present invention;

FIG. 5 is a flowchart showing a method for authenticating access to a protected network resource, in accordance with an embodiment of the present invention; and

FIG. 6 is a block diagram showing an exemplary location signature security and access system in accordance with an embodiment of the present invention.

### DETAILED DESCRIPTION OF THE PREFERRED EMBODIMENTS

An invention is disclosed for a location-specific authentication system to authenticate remote users of protected network resources by verifying the remote is located at a specific space, without the need of specific geo-location information of the remote user or transmitting specific Global Positioning System (GPS) coordinates. In general, embodiments of the present invention create a location specific signature for a particular space. The location specific signature is created by measuring the effect of intervening material on RF signals propagating through materials and accumulating a map of these effects over time. When a protected network resource is later accessed, embodiments of the present invention request current data from the remote user's receiver and verify the received data against the location specific signature for the specific space of the remote user. If the received data can be verified, access is granted to the protected resource.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

Embodiments of the present invention utilize the effect intervening materials, dielectrics and surfaces, have on RF signals to characterize a specific location and provide network security. In this manner, embodiments of the present invention can verify a remote user is located at a specific location before allowing access to protected network resources. However, it should be noted that embodiments of the present invention do not require awareness of the specific geo-location or GPS coordinates of the remote user to provide this verification. In this manner, embodiments of the present invention avoid deception of authentication data by false GPS signals from spoofed GPS signals or a GPS generator. Moreover, embodiments of the present invention avoid security risks involved in transmitting specific geo-location GPS coordinates over wide area networks, such as the Internet.

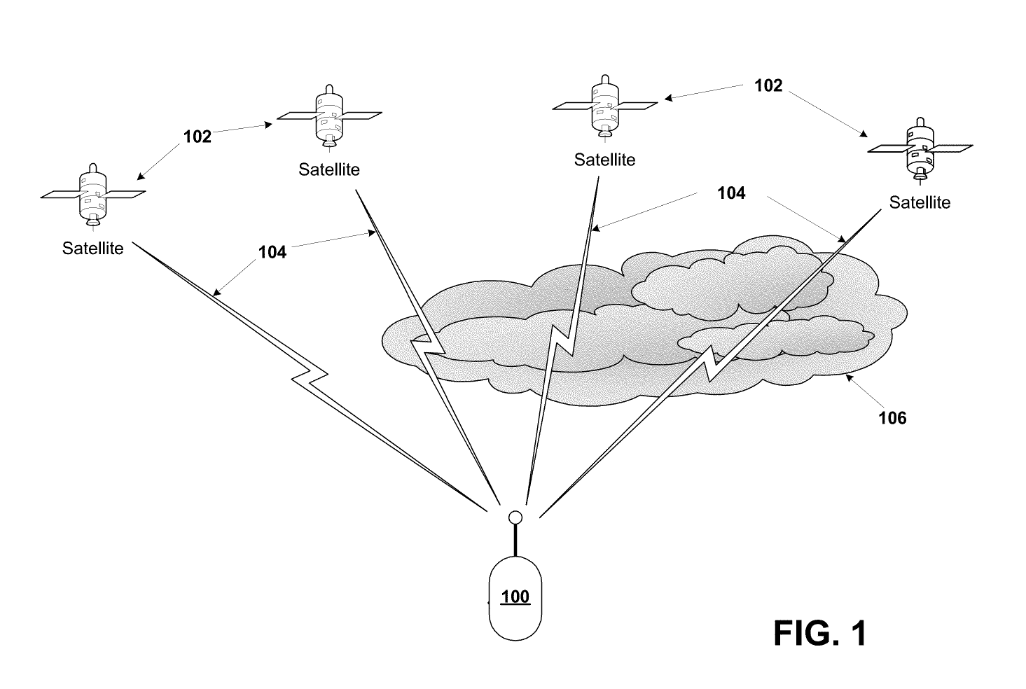

Embodiments of the present invention create a location specific signature for a particular space by measuring the effect of intervening material on RF signals, such as GPS timing signals, propagating through materials and accumulate a map of these effects over time. FIG. 1 is an illustration showing an RF receiver 100 that utilizes the effect of intervening material on GPS RF data to facilitate authentication, in accordance with an embodiment of the present invention. The RF receiver 100 makes use of remote signal sources, such as satellites 102 of the Global Positioning System (GPS), to provide timing signals 104. Although the following description is in terms of GPS technology, it should be noted that any external signals can be utilized by the embodiments of the present invention. As will be described in greater detail below, any external signals arriving from a remote source can be used. Further exemplary external signals can include cell towers, LORAN, and Global Orbiting Navigational Satellite systems (GLONASS).

The timing signals 104 include encoded time and date information that can be extracted by the RF receiver 100. By triangulation of signals from three satellites 102, the RF receiver 100 can pinpoint its current geophysical location anywhere on earth, generally to within a few meters. However, variations in the ionosphere and atmosphere 106 due to weather, barometric pressure, solar activity, and other variable and unpredictable parameters cause the purity of the timing signals 104 to fluctuate.

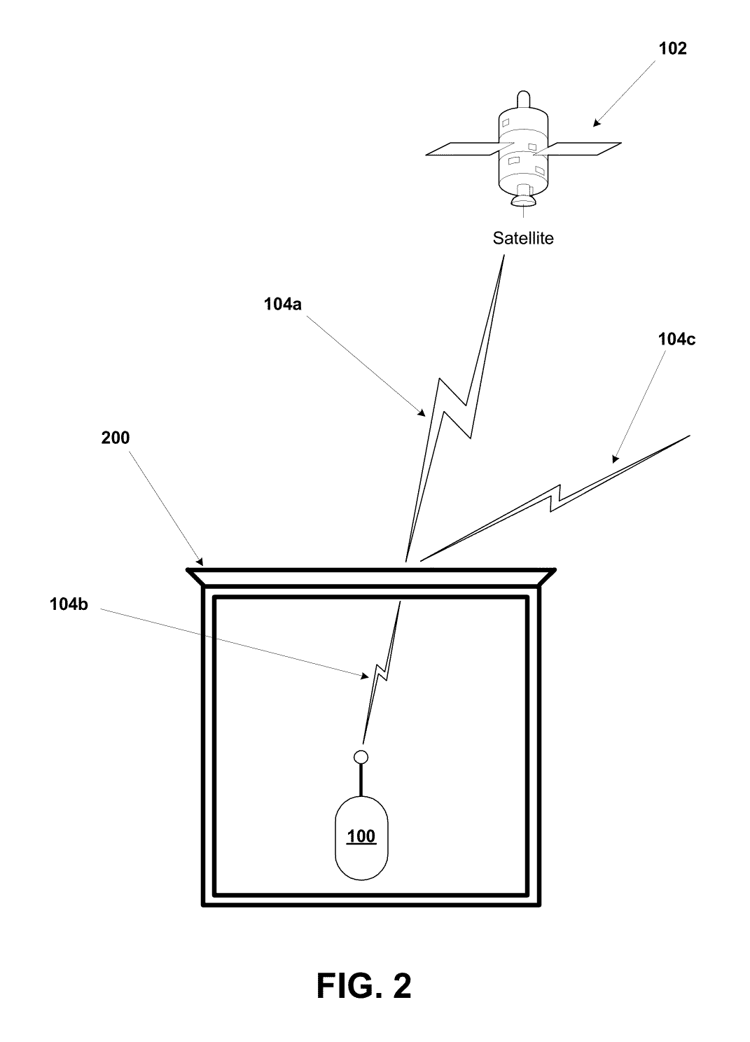

FIG. 2 is an illustration showing an exemplary single frequency receiver 100 disposed within a building 200 to illustration signal reflection, in accordance with an embodiment of the present invention. As illustrated in FIG. 2, the signal 104b received by the receiver 100 has a lower signal strength than the original signal 104a sent from the satellite 102. More specifically, the walls, ceilings and floors of the exemplary building 200 reflect a portion 104c of the GPS timing signal 104a, often causing a degree of confusion in the algorithms in GPS receivers as they try to calculate location. Since the reflected signal 104c can subsequently be reflected over and over again by subsequent surfaces, this errant signal is often referred to as “multipath interference.” As a result, a portion 104c of the strength of the original wave 104a is reflected and usually lost from such reflections. The remainder of the wave 104b arriving at the receiver 100 is proportionately diminished by the loss of the reflected signal 104c. Embodiments of the present invention utilize a measurement of the altered signal strength that has been reduced by the intervening dielectric surfaces in characterizing specific spaces for authentication purposes.

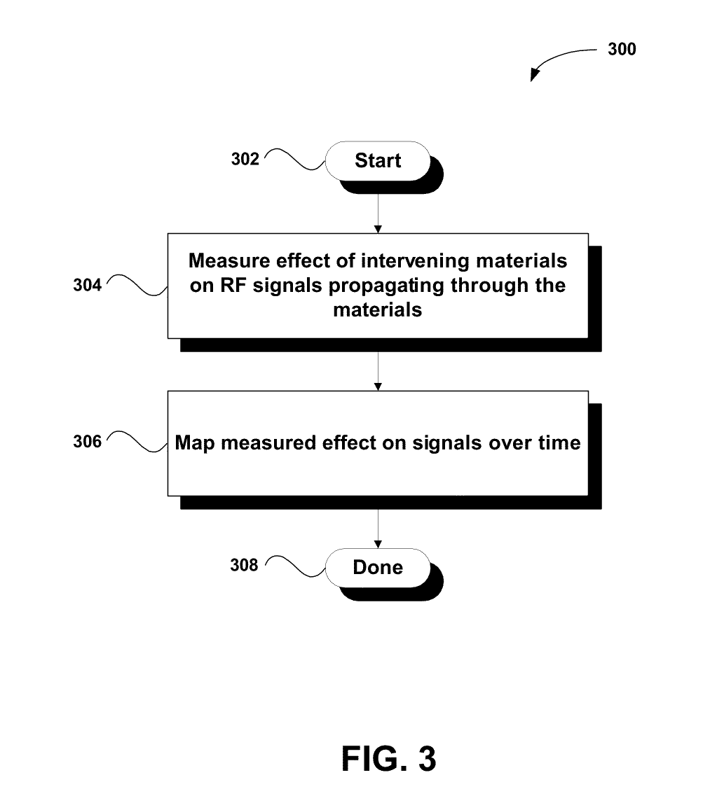

FIG. 3 is a flowchart showing a method 300 for characterizing a specific space for authentication purposes, in accordance with an embodiment of the present invention. In an initial operation 302, preprocess operations are performed. Preprocess operations can include, for example, determining the size of the specific space to be characterized, determining the amount of characterization data to be used, and other preprocess operations that will be apparent to those skilled in the art with the hindsight acquired after a careful reading of the present disclosure.

In operation 304 the effect the intervening materials surrounding the specific space have on RF signals propagating through the materials is measured. There are a number of methods that can be utilized to measure the effect intervening material has on RF signals propagating through the material. For example, in one method, highly precise dual frequency measurements of the dielectric content of the material are performed to measure the total electron content (TEC) of the materials by observing the effect on the dual frequency signals. In another method, the attenuation of single frequency signals due to loss by scattering is measured. Both techniques produce a unique location signature by accumulating TEC or signal strength data from radio wave-emitting satellites in orbit, such as GPS satellites. The specific choice of dual frequency TEC measurements vs. single frequency attenuation measurements can be dictated by environment, application requirements or cost, but both approaches produce unique location signature maps that will largely look the same.

Typically, several GPS satellites are within the line of sight of any place on Earth at any time. Furthermore, different satellites send signals from different directions into a room at any given moment and these directions all change as the satellites orbit. Therefore, over a period of hours, the variations in the intensities of signals from many directions can be detected and recorded, as discussed next with respect to operation 306.

The measured effect of the intervening materials on RF signals is mapped over time to create a location signature based on the measured effect of the intervening material surrounding the specific space, in operation 306. As mentioned above, over a period of hours, the variations in the intensities of signals from many directions can be detected and mapped. These variations in intensity with direction in the room can then be stored as a location signature to be compared with shorter-period signatures sent from the same location by someone requesting secure communications.

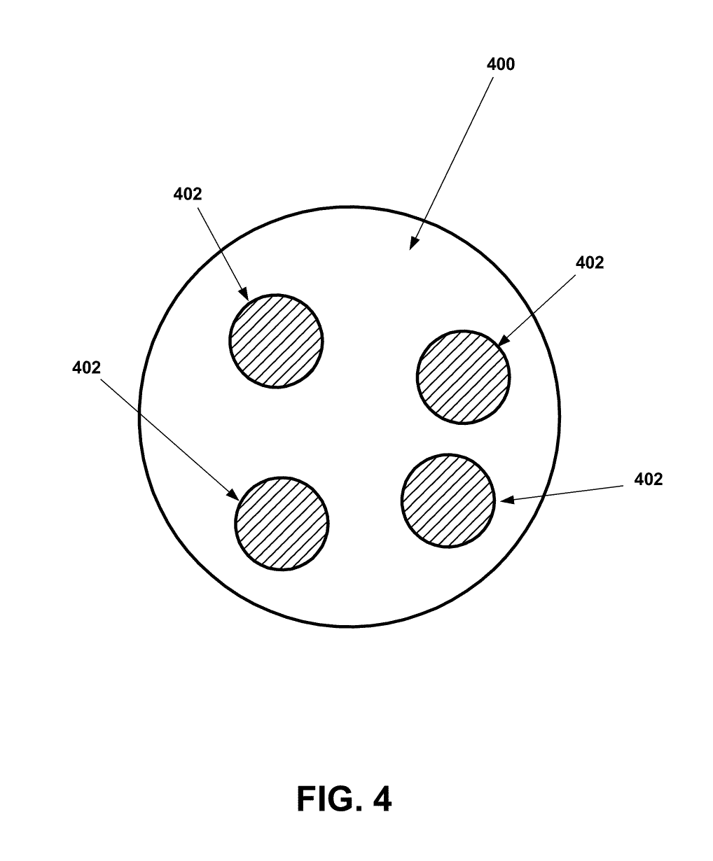

FIG. 4 is a conceptual diagram illustrating a location signature 400, in accordance with an embodiment of the present invention. In the example of FIG. 4, the location signature 400 represents the data space of values based on the measured effect of the intervening materials surrounding the specific space on RF signals mapped over time. Each RF measurement data 402 represents a smaller amount of data based on the measured effect of the intervening materials on RF signals collected over a much shorter period of time. For example, the location signature 400 can represent data collected at a receiver over a twenty-four hour period of time, while each RF measurement data 402 represents, for example, several minutes of data collected at the receiver.

Turning back to FIG. 3, post process operations are performed in operation 308. Post process operations can include, for example, storing the location signature for the specific space in a database, mapping additional specific spaces, and other post process operations that will be apparent to those skilled in the art with the hindsight acquired after a careful reading of the present disclosure.

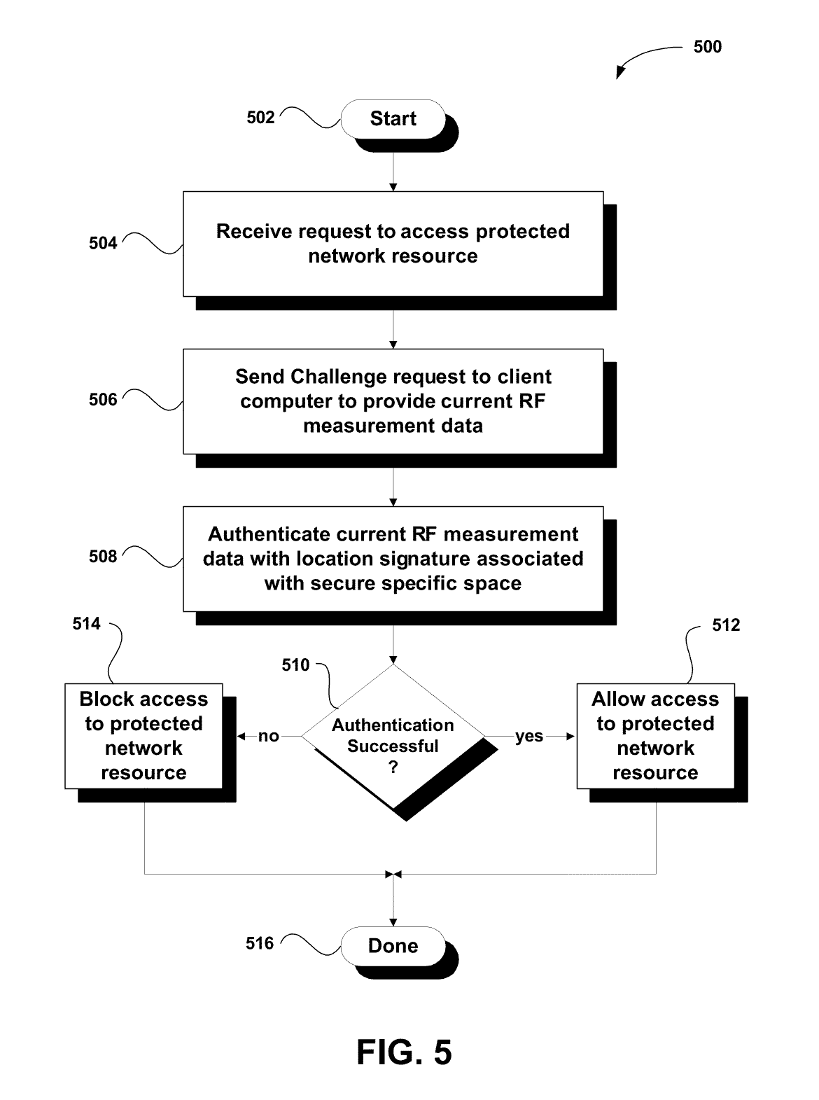

FIG. 5 is a flowchart showing a method 500 for authenticating access to a protected network resource, in accordance with an embodiment of the present invention. In an initial operation 502 preprocess operations are performed. Preprocess operations can include, for example, generating a location signature for a secure specific location, storing the location signature in database, and further operations that will be apparent to those skilled in the art with the hindsight acquired after a careful review of the present disclosure.

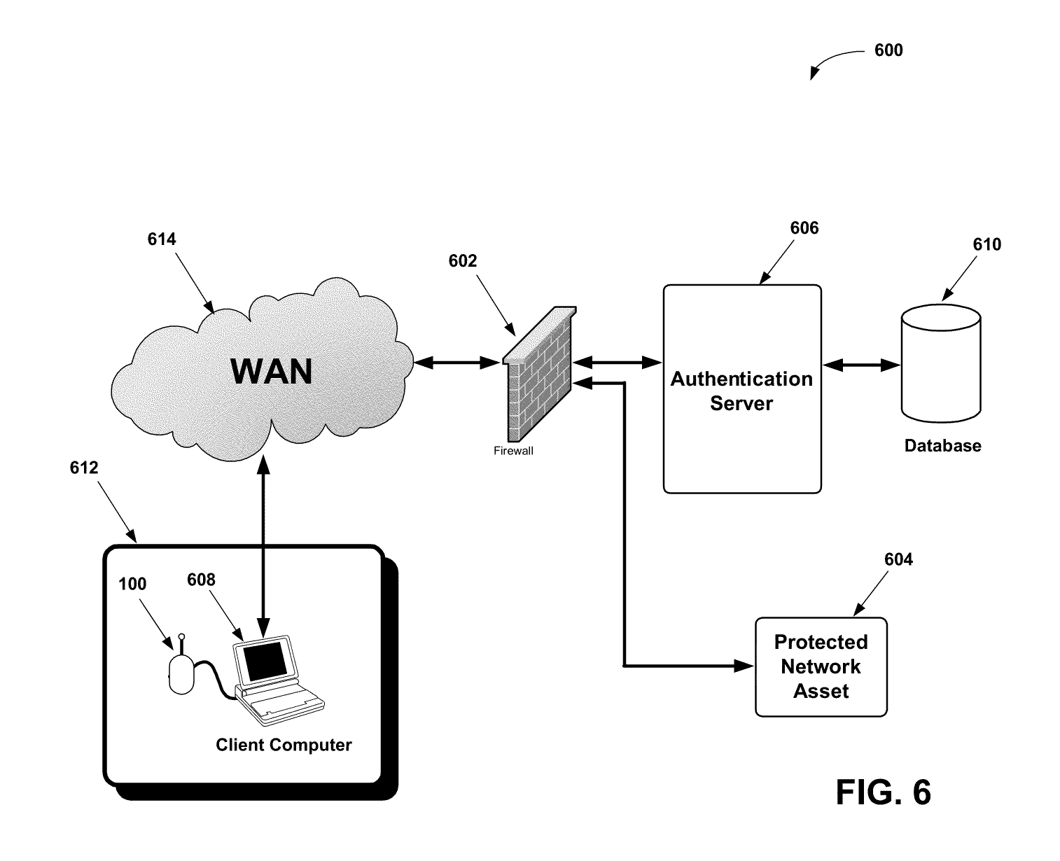

In operation 504, a request to access a protected resource is received at a network access point. FIG. 6 is a block diagram showing an exemplary location signature security and access system 600 in accordance with an embodiment of the present invention. In one embodiment, the location signature security and access system 600 provides security to protected network resources by restricting access to such resources via authenticated network equipment responsible for providing network access client computers. For example, the exemplary location signature security and access system 600 of FIG. 6 includes a firewall 602, which in the example if FIG. 6 is responsible for restricting access to protected network resources, such as the protected network asset 604. To facilitate authentication of network assets, the firewall 602 is in communication with an authentication server 606.

For example, a client computer 608 in communication with a single-frequency GPS receiver 100 can attempt to access the protected network asset 604 via a wide are network 614, such as the Internet. The exemplary system 600 is designed to ensure the access is made from the secure specific space 612. Broadly speaking, when the client computer 608 attempts to access to a protected network resource, such as protected network asset 604, the authentication server 606 provides a mechanism for the firewall 602 to authenticate the client computer 608 prior to allowing access to the protected network resource via a preconstructed location signature database 610, which stores location signature data for the secure specific space 612.

In the example of FIG. 6, the system 600 is designed to require the client computer 608 to be located at the secure specific space 612 in order to have access to the protected network asset 604. To access the protected asset, the system 600 receives a request from the client computer 608 to access the protected network asset 604.

In operation 506, a challenge request is sent to the network access point to provide current RF measured effect data for the receiver 100 in communication in communication with the client computer 608. As illustrated in FIG. 1, once the client computer 608 attempts to access the protected network asset 604, the firewall 602 recognizes that the request is to access a protected network resource and consults the authentication server 606 to authenticate the request. In response, the authentication server 606 sends a challenge request to the client computer 608. The challenge request is a request to the client computer 608 to provide current RF measurement data collected within a particular period of time of the challenge request.

In response, the client computer 608 gathers current RF measurement data via the receiver 100 and provides the data to the authentication server 606. That is, using the signal-frequency GPS receiver 100, the client computer 608 accumulates line of sight signal strength data from the ‘visible’ GPS satellites. This data can be stored as a function of azimuth and elevation. Over a period of minutes or longer, the satellites move and more data is taken from them and any others that appear above the horizon. A radio intensity map of the room in azimuth and elevation can be generated. When it has achieved sufficient resolution, the RF measurement data can be encrypted and sent to the authentication server 606.

Referring back to FIG. 5, the collected current RF measurement data then is authenticated with the location signature for the secure specific space 612, in operation 508. Referring back to FIG. 4, the location signature 400 represents the data space of values based on the measured effect of the intervening materials surrounding the specific space on RF signals mapped over time. Each RF measurement data 402 represents a smaller amount of data based on the measured effect of the intervening materials on RF signals collected over a much shorter period of time. For example, the location signature 400 can represent data collected at a receiver over a twenty-four hour period of time, while each RF measurement data 402 represents, for example, several minutes of data collected at the receiver. The location signature 400 for the secure specific space 612 is stored in the database 610 connected to the authentication server 606. Turning back to FIG. 5, the current RF measurement data for the current location of the client computer 608 is compared to the location signature for the secure specific space 612 stored in the database 610. If the current RF measurement data falls within the scope of the location signature for the secure specific space 612, authentication for the challenge request is successful.

A decision is then made as to whether the authentication for the challenge request is successful, in operation 510. If the authentication for the challenge request is successful, the method 500 branches to operation 512 where access is allowed to the protected network resource. Otherwise, access to the protected network resource is blocked, in operation 514. The method 500 then completes and post process operations are performed in operation 516. Post process operations can include issuing a temporary authentication token to the client computer allowing access to the protected network resource for a predefined period of time, facilitating access to the protected network resource, and further post process operations that will be apparent to those skilled in the art with the hindsight acquired after a careful reading of the present disclosure.

In addition to provided network resource protection, embodiments of the present invention can be utilized for a container monitoring and real time authentication system. In general, embodiments of the present invention can create an authentication table, which is a unique table of secrets to be shared between two trusted parties. To create the authentication table, timing signals at two different frequencies arriving from the same remote source are captured at a radio frequency (RF) receiver and the difference in the timing signal arrival times is extracted and compared. These differences in arrival times are converted to discrete numbers and stored into the authentication table in non-volatile memory. Copies of the authentication table at both trusted parties are then employed in a challenge/response process to aid in the authentication of one to the other.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for providing authentication in a network environment, comprising:
receiving current radio frequency (RF) measurement data from a client device, wherein the current RF measurement data is based on a measured effect of the intervening materials on RF signals received at the client device from a remote RF source;
comparing the received RF measurement data with stored RF measurement data, wherein the stored RF measurement data is based on a measured effect of the intervening materials on RF signals received at a specific space from a remote RF source and acquired at a previous time; and
providing authentication based on a result of comparing the received RF measurement data with stored RF measurement data.

2. A method as recited in claim 1, wherein the stored RF measurement data is acquired using dual frequency measurements of dielectric content of intervening material.

3. A method as recited in claim 1, wherein the stored RF measurement data is acquired by measuring attenuation of single frequency due to scattering.

4. A method as recited in claim 1, wherein the stored RF measurement data is mapped over time to create a location signature, wherein the location signature is a data space of values based on the measured effect of the intervening materials surrounding the specific space on RF signals mapped over specific period of time.

5. A method as recited in claim 4, wherein authentication is provided when the current RF measurement data falls within a scope of the location signature for the specific space.

6. A method as recited in claim 4, wherein authentication is not provided when the current RF measurement data does not fall within a scope of the location signature for the specific space.

7. A method as recited in claim 4, wherein the current RF measurement data is a data space of values based on the measured effect of the intervening materials on RF signals collected over a shorter period of time than the specific period of time used to map the stored RF measurement data.

8. A method for providing authentication in a network environment, comprising:
sending a challenge request to a client device in communication with a receiver receiving RF signals from a remote source, the challenge request requesting current radio frequency (RF) measurement data for the receiver, the current RF measurement data being based on a measured effect of the intervening materials on RF signals received at the client device from a remote RF source;
receiving the current RF measurement data for the client device at an authentication server, the authentication server having access to a location signature for a specific space, wherein the location signature is a data space of values based on the measured effect of the intervening materials surrounding the specific space on RF signals mapped over specific period of time; and
comparing the current RF measurement data to the location signature for specific space to authenticate an access request.

9. A method as recited in claim 8, wherein the location signature is acquired using dual frequency measurements of dielectric content of intervening material.

10. A method as recited in claim 8, wherein the location signature is acquired by measuring attenuation of single frequency due to scattering.

11. A method as recited in claim 8, wherein authentication is provided when the current RF measurement data falls within a scope of the location signature for the specific space.

12. A method as recited in claim 11, wherein authentication is not provided when the current RF measurement data does not fall within a scope of the location signature for the specific space.

13. A method as recited in claim 8, wherein the current RF measurement data is a data space of values based on the measured effect of the intervening materials on RF signals collected over a shorter period of time than the specific period of time used to map the location signature.

14. A system for providing security for a protected network resource, comprising:
a protected network resource;
a database storing a location signature for a specific space, wherein the location signature is a data space of values based on the measured effect of the intervening materials surrounding the specific space on RF signals mapped over specific period of time; and
an authentication computer in communication with the protected network resource and the database, wherein the authentication computer receives current radio frequency (RF) measurement data for a client device, the current RF measurement data being based on a measured effect of the intervening materials on RF signals received at the client device from a remote RF source, and wherein the authentication computer compares the current RF measurement data to the location signature for the specific space to authenticate an access request and provide access to the protected network resource.

15. A system as recited in claim 14, wherein the location signature is acquired using dual frequency measurements of dielectric content of intervening material.

16. A system as recited in claim 14, wherein the location signature is acquired by measuring attenuation of single frequency due to scattering.

17. A system as recited in claim 14, wherein the authentication computer authenticates the access request when the current RF measurement data falls within a scope of the location signature for the specific space.

18. A system as recited in claim 17, wherein the authentication computer does not authenticate the access request when the current RF measurement data does not fall within a scope of the location signature for the specific space.

19. A system as recited in claim 14, wherein the current RF measurement data is a data space of values based on the measured effect of the intervening materials on RF signals collected over a shorter period of time than the specific period of time used to map the location signature.

20. A system as recited in claim 14, wherein a single-frequency GPS receiver is used to acquire the current RF measurement data at the client device.
